(19) United States
(12) Patent Application Publication
(10) Pub. No.: US 2018/0118101 A1
(43) Pub. Date: May 3, 2018

(54) VEHICLE ILLUMINATED TRIM

(71) Applicant: Ford Global Technologies, LLC, Dearborn, MI (US)

(72) Inventors: Stuart C. Salter, White Lake, MI (US); Jeffrey Singer, Plymouth, MI (US); James J. Surman, Clinton Township, MI (US)

(73) Assignee: Ford Global Technologies, LLC

(21) Appl. No.: 15/337,560

(22) Filed: Oct. 28, 2016

(51) Int. Cl. B60Q 3/02; B60R 13/02; B60Q 3/00; F21V 8/00; F21V 23/00; G02B 1/14

(52) U.S. Cl. CPC B60Q 3/02; B60R 13/02; B60Q 3/002; B60Q 2500/10; F21V 23/005; G02B 1/14; B60R 2013/0287; G02B 6/006

(57) ABSTRACT

A vehicle film is provided herein. The vehicle film includes a base layer. A light guide is disposed above a surface of the base layer. An indicia layer is operably coupled with the light guide. The indicia layer has first and second sheets that include first and second luminescent structures respectively thereon. A light source is operably coupled with the light guide. The first and second luminescent structures luminesce in response to an excitation light emitted by the light source.

### FIELD OF THE INVENTION

The present disclosure generally relates to vehicle lighting systems, and more particularly, to vehicle lighting systems employing one or more luminescent structures.

### BACKGROUND OF THE INVENTION

Illumination arising from the use of luminescent structures offers a unique and attractive viewing experience. It is therefore desired to implement such structures in automotive vehicles for various lighting applications.

### SUMMARY OF THE INVENTION

According to one aspect of the present disclosure, a vehicle film is disclosed. The vehicle film includes a base layer. A light guide is disposed above a surface of the base layer. An indicia layer is operably coupled with the light guide. The indicia layer has first and second sheets that include first and second luminescent structures respectively thereon. A light source is operably coupled with the light guide. The first and second luminescent structures luminesce in response to an excitation light emitted by the light source.

According to another aspect of the present disclosure, a trim member is disclosed. The trim member includes a substrate and a light source configured to emit an excitation light. A film is disposed on the substrate and includes an indicia layer operably coupled with the light source. The indicia layer includes first and second luminescent structures thereon that are configured to luminesce in response to receiving the excitation light.

According to yet another aspect of the present disclosure, a trim member for a vehicle is disclosed. The trim member includes a substrate. A film is disposed on the substrate and has an embossed indicia layer. A first luminescent structure is disposed within the indicia layer and is configured to luminesce in response to receiving an excitation light. First and second light sources are configured to emit light at opposing sides of the indicia layer causing the first luminescent structure to luminesce.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1A is a side view of a luminescent structure rendered as a coating for use in a luminescent latch assembly according to one embodiment;

FIG. 1B is a top view of a luminescent structure rendered as a discrete particle according to one embodiment;

FIG. 1C is a side view of a plurality of luminescent structures rendered as discrete particles and incorporated into a separate structure;

FIG. 2 is a perspective view of a plurality of trim members disposed within a vehicle;

FIG. 3A is an enhanced view of area IIIA of FIG. 2 illustrating an indicia layer disposed within the trim member;

FIG. 3B is a side cross-sectional view of one embodiment the trim member taken along the line IIIB-IIIB of FIG. 3A;

FIG. 4 is a side cross-sectional view of one embodiment the trim member taken along the line IV-IV of FIG. 2;

FIG. 5 is a side cross-sectional view of an alternate embodiment the trim member taken along the line IV-IV of FIG. 2;

FIG. 6 is a side cross-sectional view of an alternate embodiment the trim member taken along the line IV-IV of FIG. 2; and

FIG. 7 is a block diagram showing the vehicle having the trim member therein operably coupled with one or more controls within the vehicle.

### DETAILED DESCRIPTION OF THE PREFERRED EMBODIMENTS

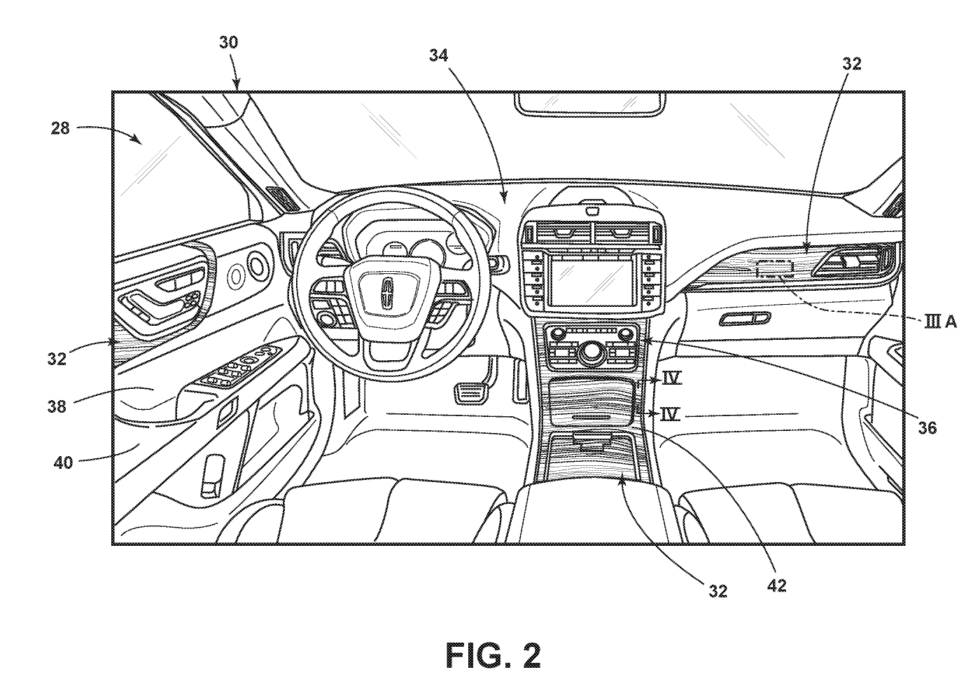

For purposes of description herein, the terms “upper,” “lower,” “right,” “left,” “rear,” “front,” “vertical,” “horizontal,” and derivatives thereof shall relate to the invention as oriented in FIG. 2. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a trim member. The trim member may advantageously employ one or more phosphorescent and/or luminescent structures to illuminate in response to predefined events. The one or more luminescent structures may be configured to convert ambient light and/or light received from an associated light source and re-emit the light at a different wavelength typically found in the visible spectrum.

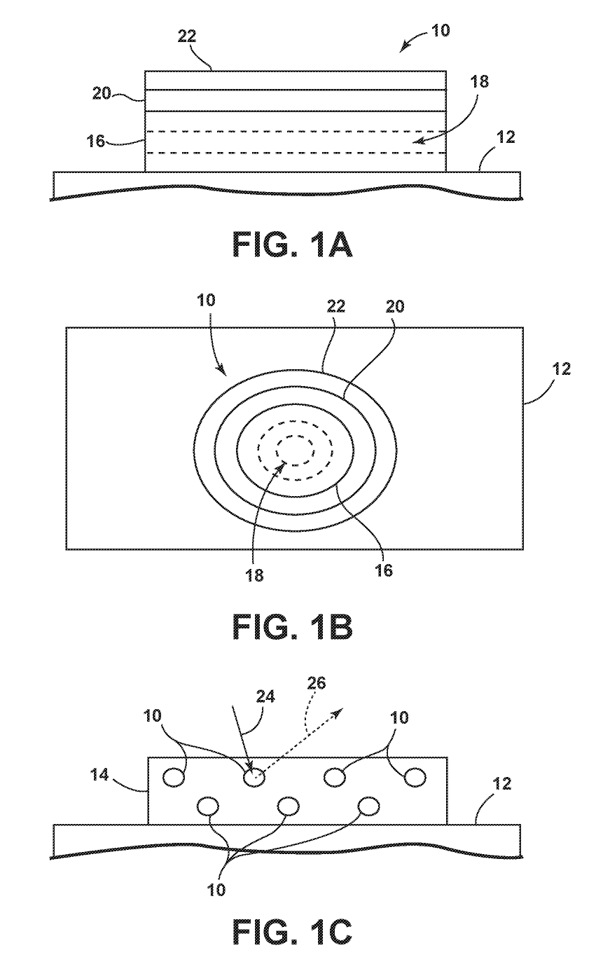

Referring to FIGS. 1A-1C, various exemplary embodiments of luminescent structures 10 are shown, each capable of being coupled to a substrate 12, which may correspond to a vehicle fixture or vehicle related piece of equipment. In FIG. 1A, the luminescent structure 10 is generally shown rendered as a coating (e.g., a film 46) that may be applied to a surface of the substrate 12. In FIG. 1B, the luminescent structure 10 is generally shown as a discrete particle capable of being integrated with a substrate 12. In FIG. 1C, the luminescent structure 10 is generally shown as a plurality of discrete particles that may be incorporated into a support medium 14 (e.g., a film 46) that may then be applied (as shown) or integrated with the substrate 12.

At the most basic level, a given luminescent structure 10 includes an energy conversion layer 16 that may include one or more sublayers, which are exemplarily shown through broken lines in FIGS. 1A and 1B. Each sublayer of the energy conversion layer 16 may include one or more luminescent materials 18 having energy converting elements with phosphorescent or fluorescent properties. Each luminescent material 18 may become excited upon receiving an excitation light 24 of a specific wavelength, thereby causing the light to undergo a conversion process. Under the principle of down conversion, the excitation light 24 is converted into a longer wavelength, converted light 26 that is outputted from the luminescent structure 10. Conversely, under the principle of up conversion, the excitation light 24 is converted into a shorter wavelength light that is outputted from the luminescent structure 10. When multiple distinct wavelengths of light are outputted from the luminescent structure 10 at the same time, the wavelengths of light may mix together and be expressed as a multicolor light.

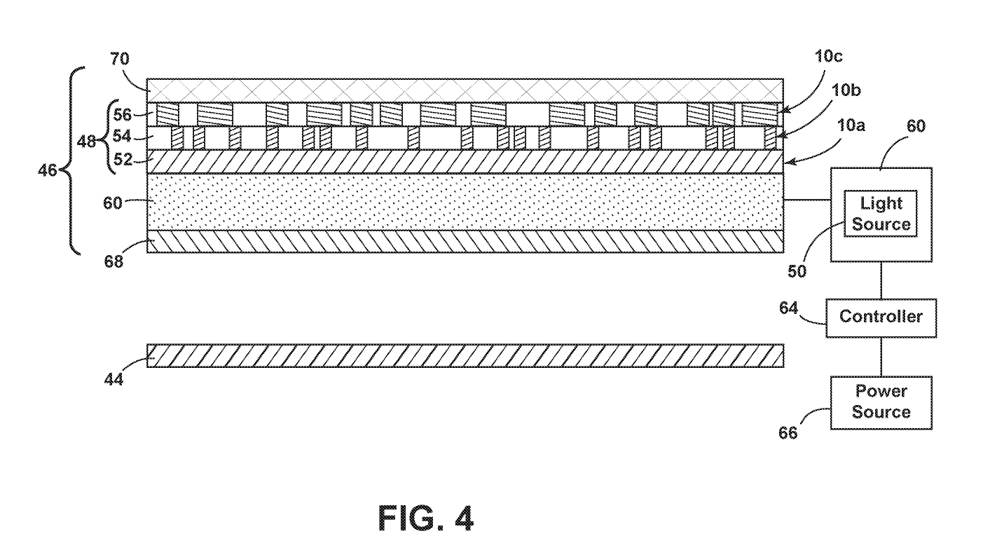

Light emitted by a light source 50 (FIG. 4) is referred to herein as excitation light 24 and is illustrated herein as solid arrows. In contrast, light emitted from the luminescent structure 10 is referred to herein as converted light 26 and is illustrated herein as broken arrows. The mixture of excitation light 24 and converted light 26 that may be emitted simultaneously is referred to herein as emitted light.

The energy conversion layer 16 may be prepared by dispersing the luminescent material 18 in a polymer matrix to form a homogenous mixture using a variety of methods. Such methods may include preparing the energy conversion layer 16 from a formulation in a liquid carrier support medium 14 and coating the energy conversion layer 16 to a desired substrate 12. The energy conversion layer 16 may be applied to a substrate 12 by painting, screen-printing, spraying, slot coating, dip coating, roller coating, and bar coating. Alternatively, the energy conversion layer 16 may be prepared by methods that do not use a liquid carrier support medium 14. For example, the energy conversion layer 16 may be rendered by dispersing the luminescent material 18 into a solid-state solution (homogenous mixture in a dry state) that may be incorporated in a polymer matrix, which may be formed by extrusion, injection molding, compression molding, calendaring, thermoforming, etc. The energy conversion layer 16 may then be integrated into a substrate 12 using any methods known to those skilled in the art. When the energy conversion layer 16 includes sublayers, each sublayer may be sequentially coated to form the energy conversion layer 16. Alternatively, the sublayers can be separately prepared and later laminated or embossed together to form the energy conversion layer 16. Alternatively still, the energy conversion layer 16 may be formed by coextruding the sublayers.

In some embodiments, the converted light 26 that has been down converted or up converted may be used to excite other luminescent material(s) 18 found in the energy conversion layer 16. The process of using the converted light 26 outputted from one luminescent material 18 to excite another, and so on, is generally known as an energy cascade and may serve as an alternative for achieving various color expressions. With respect to either conversion principle, the difference in wavelength between the excitation light 24 and the converted light 26 is known as the Stokes shift and serves as the principle driving mechanism for an energy conversion process corresponding to a change in wavelength of light. In the various embodiments discussed herein, each of the luminescent structures 10 may operate under either conversion principle.

Referring back to FIGS. 1A and 1B, the luminescent structure 10 may optionally include at least one stability layer 20 to protect the luminescent material 18 contained within the energy conversion layer 16 from photolytic and thermal degradation. The stability layer 20 may be configured as a separate layer optically coupled and adhered to the energy conversion layer 16. Alternatively, the stability layer 20 may be integrated with the energy conversion layer 16. The luminescent structure 10 may also optionally include a protective layer 22 optically coupled and adhered to the stability layer 20 or other layer (e.g., the conversion layer 16 in the absence of the stability layer 20) to protect the luminescent structure 10 from physical and chemical damage arising from environmental exposure. The stability layer 20 and/or the protective layer 22 may be combined with the energy conversion layer 16 through sequential coating or printing of each layer, sequential lamination or embossing, or any other suitable means.

Additional information regarding the construction of luminescent structures 10 is disclosed in U.S. Pat. No. 8,232,533 to Kingsley et al., the entire disclosure of which is incorporated herein by reference. For additional information regarding fabrication and utilization of luminescent materials to achieve various light emissions, refer to U.S. Pat. No. 8,207,511 to Bortz et al., U.S. Pat. No. 8,247,761 to Agrawal et al., U.S. Pat. No. 8,519,359 to Kingsley et al., U.S. Pat. No. 8,664,624 to Kingsley et al., U.S. Patent Publication No. 2012/0183677 to Agrawal et al., U.S. Pat. No. 9,057,021 to Kingsley et al., and U.S. Pat. No. 8,846,184 to Agrawal et al., all of which are incorporated herein by reference in its entirety.

According to one embodiment, the luminescent material 18 may include organic or inorganic fluorescent dyes including rylenes, xanthenes, porphyrins, and phthalocyanines. Additionally, or alternatively, the luminescent material 18 may include phosphors from the group of Ce-doped garnets such as YAG:Ce and may be a short-persistence luminescent material 18. For example, an emission by Ce³⁺ is based on an electronic energy transition from 4D′ to 4f′ as a parity allowed transition. As a result of this, a difference in energy between the light absorption and the light emission by Ce³⁺ is small, and the luminescent level of Ce³⁺ has an ultra-short lifespan, or decay time, of 10⁻⁸ to 10⁻⁷ seconds (10 to 100 nanoseconds). The decay time may be defined as the time between the end of excitation from the excitation light 24 and the moment when the light intensity of the converted light 26 emitted from the luminescent structure 10 drops below a minimum visibility of 0.32 mcd/m². A visibility of 0.32 mcd/m² is roughly 100 times the sensitivity of the dark-adapted human eye, which corresponds to a base level of illumination commonly used by persons of ordinary skill in the art.

According to one embodiment, a Ce³⁺ garnet may be utilized, which has a peak excitation spectrum that may reside in a shorter wavelength range than that of conventional YAG:Ce-type phosphors. Accordingly, Ce³⁺ has short-persistence characteristics such that its decay time may be 100 milliseconds or less. Therefore, in some embodiments, the rare earth aluminum garnet type Ce phosphor may serve as the luminescent material 18 with ultra-short-persistence characteristics, which can emit the converted light 26 by absorbing purple to blue excitation light 24 emitted from a light source 50. According to one embodiment, a ZnS:Ag phosphor may be used to create a blue converted light 26. A ZnS:Cu phosphor may be utilized to create a yellowish-green converted light 26. A Y₂O₂S:Eu phosphor may be used to create red converted light 26. Moreover, the aforementioned phosphorescent materials may be combined to form a wide range of colors, including white light. It will be understood that any short-persistence luminescent material known in the art may be utilized without departing from the teachings provided herein. Additional information regarding the production of short-persistence luminescent materials is disclosed in U.S. Pat. No. 8,163,201 to Kingsley et al., the entire disclosure of which is incorporated herein by reference.

Additionally, or alternatively, the luminescent material 18, according to one embodiment, disposed within the luminescent structure 10 may include a long-persistence luminescent material 18 that emits the converted light 26, once charged by the excitation light 24. The excitation light 24 may be emitted from any excitation source (e.g., any natural light source, such as the sun, and/or any artificial light source 50). The long-persistence luminescent material 18 may be defined as having a long decay time due to its ability to store the excitation light 24 and release the converted light 26 gradually, for a period of several minutes or hours, once the excitation light 24 is no longer present.

The long-persistence luminescent material 18, according to one embodiment, may be operable to emit light at or above an intensity of 0.32 mcd/m² after a period of 10 minutes. Additionally, the long-persistence luminescent material 18 may be operable to emit light above or at an intensity of 0.32 mcd/m² after a period of 30 minutes and, in some embodiments, for a period substantially longer than 60 minutes (e.g., the period may extend 24 hours or longer, and in some instances, the period may extend 48 hours). Accordingly, the long-persistence luminescent material 18 may continually illuminate in response to excitation from any light source 50 that emits the excitation light 24, including, but not limited to, natural light sources (e.g., the sun) and/or any artificial light source 50. The periodic absorption of the excitation light 24 from any excitation source may provide for a substantially sustained charge of the long-persistence luminescent material 18 to provide for consistent passive illumination. In some embodiments, a light sensor may monitor the illumination intensity of the luminescent structure 10 and actuate an excitation source when the illumination intensity falls below 0.32 mcd/m², or any other predefined intensity level.

The long-persistence luminescent material 18 may correspond to alkaline earth aluminates and silicates, for example doped di-silicates, or any other compound that is capable of emitting light for a period of time once the excitation light 24 is no longer present. The long-persistence luminescent material 18 may be doped with one or more ions, which may correspond to rare earth elements, for example, Eu²⁺, Tb³⁺ and/or Dy³. According to one non-limiting exemplary embodiment, the luminescent structure 10 includes a phosphorescent material in the range of about 30% to about 55%, a liquid carrier medium in the range of about 25% to about 55%, a polymeric resin in the range of about 15% to about 35%, a stabilizing additive in the range of about 0.25% to about 20%, and performance-enhancing additives in the range of about 0% to about 5%, each based on the weight of the formulation.

The luminescent structure 10, according to one embodiment, may be a translucent white color, and in some instances reflective, when unilluminated. Once the luminescent structure 10 receives the excitation light 24 of a particular wavelength, the luminescent structure 10 may emit any color light (e.g., blue or red) therefrom at any desired brightness. According to one embodiment, a blue emitting phosphorescent material may have the structure Li₂ZnGeO₄ and may be prepared by a high temperature solid-state reaction method or through any other practicable method and/or process. The afterglow may last for a duration of 2-8 hours and may originate from the excitation light 24 and d-d transitions of Mn²⁺ ions.

According to an alternate non-limiting exemplary embodiment, 100 parts of a commercial solvent-borne polyurethane, such as Mace resin 107-268, having 50% solids polyurethane in toluene/isopropanol, 125 parts of a blue-green long-persistence phosphor, such as Performance Indicator PI-BG20, and 12.5 parts of a dye solution containing 0.1% Lumogen Yellow F083 in dioxolane may be blended to yield a low rare earth mineral luminescent structure 10. It will be understood that the compositions provided herein are non-limiting examples. Thus, any phosphor known in the art may be utilized within the luminescent structure 10 without departing from the teachings provided herein. Moreover, it is contemplated that any long-persistence phosphor known in the art may also be utilized without departing from the teachings provided herein.

Additional information regarding the production of long-persistence luminescent materials is disclosed in U.S. Pat. No. 8,163,201 to Agrawal et al., the entire disclosure of which is incorporated herein by reference. For additional information regarding long-persistence phosphorescent structures, refer to U.S. Pat. No. 6,953,536 to Yen et al., U.S. Pat. No. 6,117,362 to Yen et al., and U.S. Pat. No. 8,952,341 to Kingsley et al., all of which are incorporated herein by reference in their entirety.

Referring to FIG. 2, an interior 28 of a vehicle 30 is generally illustrated having a plurality of trim members 32 disposed therein. The trim member is configured to attach to a vehicle structure, such as an instrument panel 34, a center stack 36, a door panel 38, an armrest 40, a console 42, a cup holder, and/or any other structure within the vehicle 30. The trim member 32 may confer any aesthetic appearance, such as a wood grain pattern as illustrated in FIG. 2, and may include a substrate 44 (FIG. 4) and a decorative film 46 (FIG. 4) disposed on the substrate 44. In alternate embodiments, the film 46 may confer a variety of metallic appearances, such as chrome, gold, aluminum, etc., with a plethora of possible textured finishes, such as a darkened or black appearance, etc. Additionally, the film 46 may be used in conjunction with or replaced by any other practicable material, such as a fabric, metal, etc., without departing from the scope of the present disclosure.

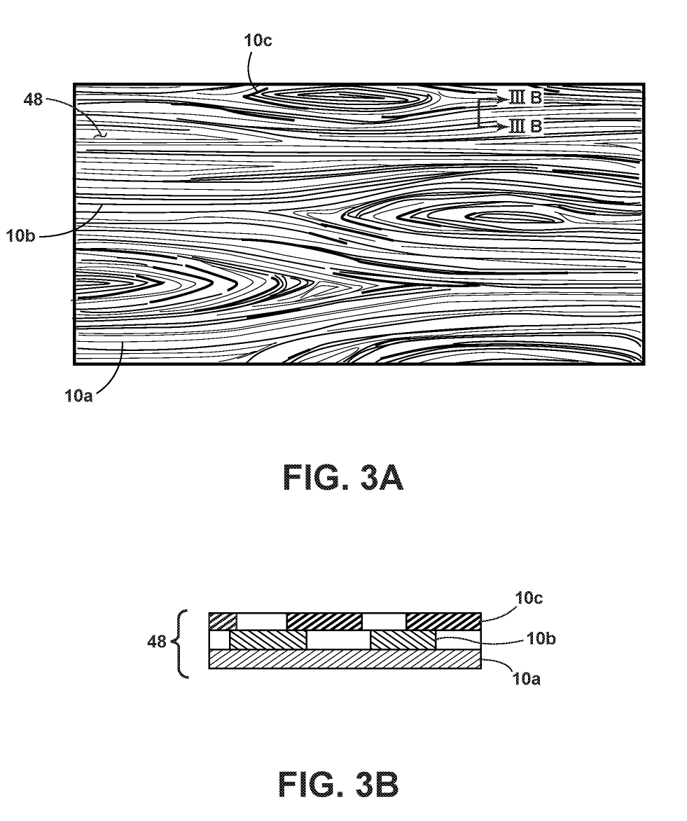

Referring to FIGS. 3A-4, the film 46 includes an indicia layer 48. The indicia layer 48 may be configured as a coating of ink or other suitable material and is printed or otherwise applied to form indicia. The coating may be disposed on the film 46 through any method known in the art, including, but not limited to, sputter deposition, vacuum deposition (vacuum evaporation coating), electroplating, or directly printed onto the film 46 by a computer printer after preparation of the desired pattern through a computer.

The indicia layer 48, and/or coating, includes one or more luminescent structures 10a, 10b 10c that luminesce in response to receiving excitation light 24 from a light source 50 disposed within the vehicle 30 or natural and/or ambient light that enters the vehicle 30. As illustrated in FIGS. 3A-4, the indicia layer 48 includes three luminescent structures 10a, 10b, 10c that provide a wood-like appearance. The first luminescent structure 10a may provide a first colored background, for example, a brown transparent background suggestive of wood. A second luminescent structure 10b may provide a grain appearance in a second color. Likewise, the third luminescent structure 10c may include additional detail of the grain appearance in a third color. It will be appreciated that the indicia layer 48 may include a number of various colors and/or materials to form any desired appearance of the indicia layer 48. Alternatively or in addition, the film 46 can be made with other known processes and equipment, and may comprise non-polymeric materials, such as glasses, ceramics, metals, and/or other suitable materials.

The luminescent structures 10a, 10b, 10c may have varied charged (i.e., luminescent) and/or uncharged (i.e., non-luminescent) color appearances such that the one or more luminescent structures 10a, 10b, 10c may define the desired pattern, such as the wood grain pattern, of the film 46. In some embodiments, the first, second, and/or third luminescent structures 10a, 10b, 10c each have substantially different (e.g., non-overlapping and/or offset) absorbance and/or luminesce wavelength spectrums such that different luminescent structures 10a, 10b, 10c may be independently illuminated. That is, the luminescent structures 10a, 10b, 10c may be formulated to have non-overlapping absorption spectrums and Stokes shifts that yield different emission spectrums. Also, in formulating the luminescent structures 10a, 10b, 10c, care should be taken in choosing the associated Stokes shifts such that the converted light 26 emitted from one of the luminescent structures 10a, 10b, 10c does not excite the other, unless so desired. For energy conversion layers 16 containing more than two distinct luminescent materials 18, a greater diversity of colors may be achieved. Contemplated colors include red, green, blue, and combinations thereof, including white, all of which may be achieved by selecting and exciting the appropriate luminescent materials 18. In some embodiments, the first luminescent structure 10a may be a phosphor material while the second luminescent structure 10b may be a dye.

According to one embodiment, the luminescent structures 10a, 10b, 10c within the film 46 include a long-persistence luminescent material 18. The luminescent structures 10a, 10b, 10c may luminesce in response to receiving natural and/or artificial excitation light 24. Thus, according to one embodiment, the luminescent structures 10a, 10b, 10c may be activated by UV light. Accordingly, the luminescent structures 10a, 10b, 10c may actively (i.e., excited by the light source 50) and/or passively (excited by the sun) luminesce. In embodiments in which the luminescent structures 10a, 10b, 10c are passively excitable, a unique luminescent pattern may be exhibited each day and/or each time the trim member 32 is excited due to variations in the amount of natural and/or ambient excitation light 24 that is directed towards the various portions of the trim member 32.

Referring to FIG. 4, the indicia layer 48 includes three separate sheets 52, 54, 56 that are adhered to one another through the usage of an adhesive layer 58. The adhesive layer 58 may be an optically clear adhesive. As used herein, the term “optically clear” refers to an adhesive that has a high light transmittance over at least a portion of the non-visible and/or visible light spectrum (about 250 to about 700 nanometers) and that exhibits low haze. Both the luminous transmission and the haze can be determined using, for example, the method of ASTM-D 1003-95. In one embodiment, the adhesive has about 10% haze or less, particularly about 5% haze or less, and more particularly about 2% haze or less.

A light guide 60 is disposed below the indicia layer 48 and is operably coupled with the light source 50 disposed within the vehicle 30. The light guide 60 may be made of a clear thermoplastic material, such as an acrylic material, or any other transparent and/or translucent material. The light guide 60 may be a substantially transparent or translucent guide suitable for transmitting light. The light guide 60 may be a flexible light guide, wherein a suitable flexible material is used to create the light guide 60. Such flexible materials include urethanes, silicone, thermoplastic polyurethane (TPU), or any other like optical grade flexible materials.

Further, the light guide 60 may be formed from a rigid material that is comprised of a curable substrate such as a polymerizable compound, a mold in clear (MIC) material and/or mixtures thereof. Acrylates are also commonly used for forming rigid light pipes, as well as poly-methyl methacrylate (PMMA), which is a known substitute for glass. A polycarbonate material may also be used in an injection molding process to form the rigid light guide 60. Whether the light guide 60 is flexible or rigid, the light guide 60, when formed, is substantially optically transparent and/or translucent and capable of transmitting light. The light guide 60 may be referred to as a light pipe, a light plate, a light bar or any other light carrying or transmitting substrate made from a clear or substantially translucent material.

The light source 50 may include any form of light source. For example, fluorescent lighting, light emitting diodes (LEDs), organic LEDs (OLEDs), polymer LEDs (PLEDs), solid-state lighting, or any other form of lighting configured to emit light may be utilized. According to one embodiment, the light source 50 may be configured to emit a wavelength of excitation light 24 that is characterized as ultraviolet light (˜10-400 nanometers in wavelength), violet light (˜380-450 nanometers in wavelength), blue light (˜450-495 nanometers in wavelength), and/or infrared light (IR) (˜700 nm-1 mm in wavelength) to take advantage of the relative low cost attributable to those types of LEDs. In alternate embodiments, the light source 50 may be disposed or oriented in any other configuration within the trim member 32 without departing from the scope of the present disclosure.

The light source 50 may be disposed on a printed circuit board (PCB) 62, or any other type of circuit board, that is operably coupled with a controller 64 having control circuitry including LED drive circuitry for controlling activation and deactivation of the light source 50 and a power source 66. The PCB 62 may be any type of circuit board including, but not limited to, any flexible PCB and/or rigid PCB.

A base layer 68 is disposed below the light guide 60. The base layer 68 may be configured to assist in attachment of the film 46 to a desired substrate 44. The film 46 may be coupled to the substrate 44 through any means known in the art, including but not limited to, through adhesive processes, printing processes, and in-mold decoration processes. The base layer 68 may be etched or include a material therein for directing excitation light 24 emitted from the light source 50 towards the indicia layer 48.

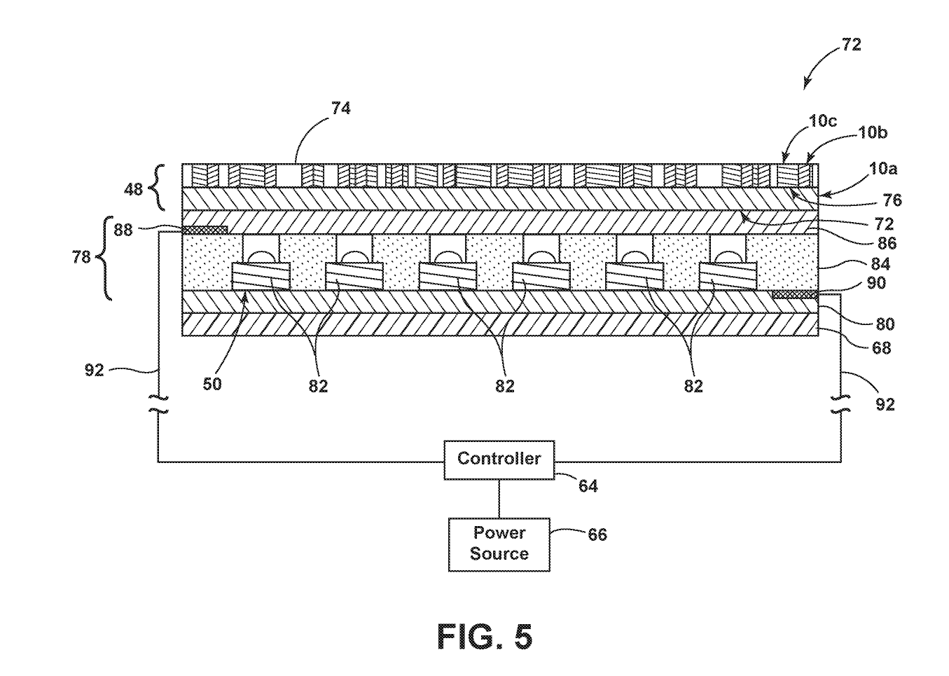

A protective layer 70, or laminate, may be positioned over the indicia layer 48 and may protect the indicia layer 48 from damage and wear during use. The indicia layer 48 may also protect the trim member 32 from the environmental contaminants, such as dirt and water that may come in contact with the interior 28 of the vehicle 30. The protective layer 70 may be formed of any practicable transparent and/or translucent material known in the art and may absorb UV light, thereby preventing sunlight from exciting the luminescent structure 10 in some embodiments. In alternative embodiments, the protective layer 70 may be configured to absorb light of any other wavelength, or multiple wavelengths. In some embodiments, as illustrated in FIG. 5, the film 46 may not include the protective layer 70 without departing from the scope of the present disclosure. Alternatively, the protective layer 70 may allow UV light, or any other desired wavelength of light, to pass therethrough.

In some embodiments, a first light source may be an artificial light source 50 that emits light towards a first side 72 or surface of the indicia layer 48. A second light source may be a natural light source (e.g., the sun) that is configured to emit light at a second side 74, or surface, of the indicia layer 48 causing the luminescent structures 10a, 10b, 10c to luminesce when excitation light 24 is received by either light source. The first and second sides 72, 74 may be on opposing sides of the indicia layer 48. Also, the first and second light source may be in any other relationship to the indicia layer 48, such as on a common side 72, 74 thereof, without departing from the scope of the present disclosure.

Referring to FIG. 5, the indicia layer 48 may be coupled with a light-producing assembly 78 and, in some embodiments, any of the luminescent structures 10a, 10b, 10c may be disposed on a single sheet 76 through any means known in the art. The second and third luminescent structures 10b, 10c may be disposed on the first luminescent structure 10a that forms the background of the indicia layer 48. Alternatively, any and/or all of the luminescent structures 10a, 10b, 10c may be on a common sheet 76 such that the luminescent structures 10a, 10b, 10c are all linearly aligned.

The light-producing assembly 78 may correspond to a thin-film or printed light emitting diode (LED) assembly and includes the base layer 68 as its lowermost layer. The base layer 68 may include a polycarbonate, poly-methyl methacrylate (PMMA), or polyethylene terephthalate (PET) material, or any other material known in the art, on the order of 0.005 to 0.060 inches thick and is arranged over the base layer 68. Alternatively, as a cost saving measure, the base layer 68 may directly correspond to a preexisting vehicle structure (e.g., the substrate 44).

The light-producing assembly 78 includes a positive electrode 80 arranged over the base layer 68. The positive electrode 80 includes a conductive epoxy such as, but not limited to, a silver-containing or copper-containing epoxy. The positive electrode 80 is electrically connected to at least a portion of a plurality of LED sources 82 arranged within a semiconductor ink 84 and applied over the positive electrode 80. Likewise, a negative electrode 86 is also electrically connected to at least a portion of the LED sources 82. The negative electrode 86 is arranged over the semiconductor ink 84 and includes a transparent or translucent conductive material such as, but not limited to, indium tin oxide.

Additionally, each of the positive and negative electrodes 80, 86 are electrically connected to the controller 64 and a power source 66 via a corresponding bus bar 88, 90 and conductive leads 92. The bus bars 88, 90 may be printed along opposite edges of the positive and negative electrodes 80, 86 and the points of connection between the bus bars 88, 90 and the conductive leads 92 may be at opposite corners of each bus bar 88, 90 to promote uniform current distribution along the bus bars 88, 90. It should be appreciated that in alternate embodiments, the orientation of components within the light-producing assembly 78 may be altered without departing from the concepts of the present disclosure. For example, the negative electrode 86 may be disposed below the semiconductor ink 84 and the positive electrode 80 may be arranged over the aforementioned semiconductor ink 84. Likewise, additional components, such as the bus bars 88, 90 may also be placed in any orientation.

The LED sources 82 may be dispersed in a random or controlled fashion within the semiconductor ink 84 and may be configured to emit focused or non-focused light. The LED sources 82 may correspond to micro-LEDs of gallium nitride elements on the order of about 5 to about 400 microns in size and the semiconductor ink 84 may include various binders and dielectric material including, but not limited to, one or more of gallium, indium, silicon carbide, phosphorous, and/or translucent polymeric binders.

The semiconductor ink 84 can be applied through various printing processes, including ink jet and silk screen processes to selected portion(s) of the positive electrode 80. More specifically, it is envisioned that the LED sources 82 are dispersed within the semiconductor ink 84, and shaped and sized such that a substantial quantity of the LED sources 82 align with the positive and negative electrodes 80, 86 during deposition of the semiconductor ink 84. The portion of the LED sources 82 that ultimately are electrically connected to the positive and negative electrodes 80, 86 may be illuminated by a combination of the bus bars 88, 90, the controller 64, power source 66, and conductive leads 92. According to one embodiment, the power source 66 may correspond to a vehicular power source 66 operating at 12 to 16 VDC. Additional information regarding the construction of light-producing assemblies is disclosed in U.S. Patent Publication No. 2014/0264396 to Lowenthal et al., the entire disclosure of which is incorporated herein by reference.

The LED sources 82 may emit a wavelength of excitation light 24 that excites each of the luminescent structures 10a, 10b, 10c to luminesce in varied colors. Additionally, and/or alternatively, the LED sources 82 may emit a range of excitation light 24 wavelengths such that each luminescent structure 10a, 10b, 10c may luminesce independently of the other luminescent structures 10a, 10b, 10c.

It will be understood that the foregoing description of the light-producing assembly 78 may be applied to form a single continuous light source 50 and/or a plurality of individual light sources 50. In examples where there are a plurality of light sources 50, some or all of the light sources 50 may be independently electrically connected (e.g., through a conductive ink). In independently electrically connected examples of the light source 50, each of the light sources 50 may be independently addressable, which may allow the controller 64 to create static and dynamic patterns of light by independently illuminating certain light sources 50 and not others. The light sources may be individually affixed to a circuit. In some instances, a machine may function to transfer unpackaged light sources from a substrate such as a “wafer tape” to a product substrate, such as a circuit substrate. The direct transfer of unpackaged light sources may reduce the thickness of an end product compared to a similar product produced by conventional means, as well as the amount of time and/or cost to manufacture the product substrate. Additional information on the formation of the plurality of light sources 50 and/or variously configured light-producing assemblies 78 is disclosed in U.S. Patent Publication No. 2015/0124573 to Peterson et al. and U.S. Patent Publication No. 2016/0276205 to Huska et al., both of which are incorporated herein by reference in its entirety.

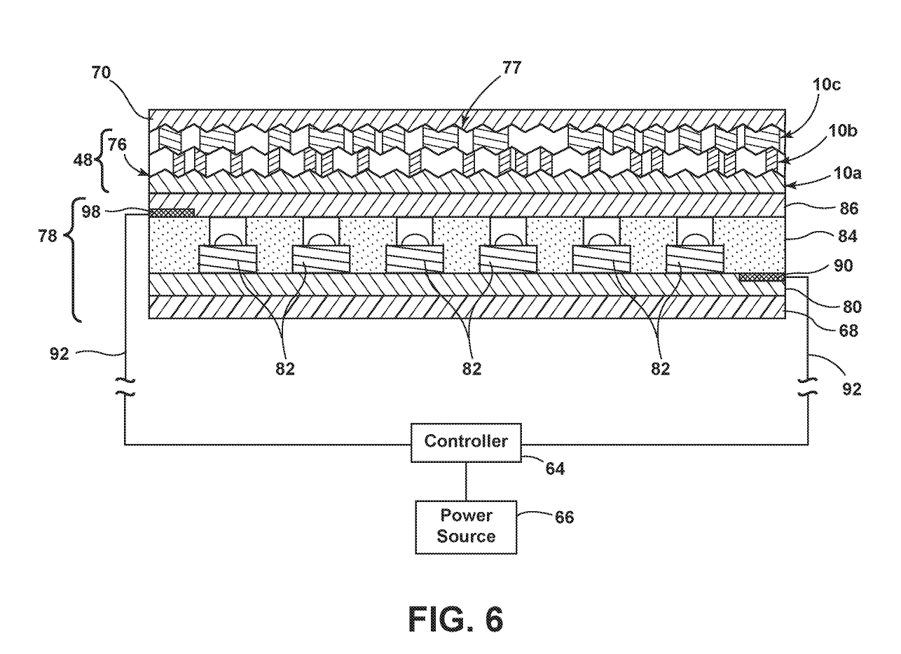

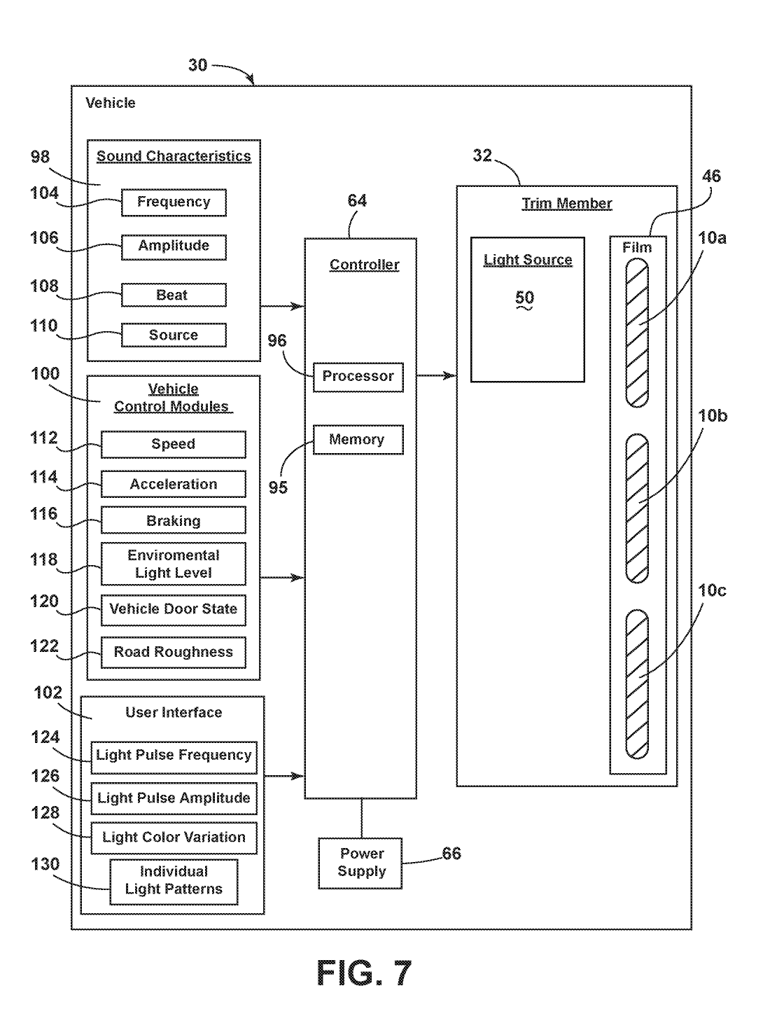

Referring to FIGS. 6 and 7, the indicia layer 48 may be embossed to give an appearance of depth to the film 46. Any method of embossing the film 46 may be utilized including a blown method, whereby a molten flexible synthetic resin is inflated by blowing air into the flexible synthetic resin, and a casting method, whereby a plurality of shaping rollers are utilized. The embossing may create a diffraction grating 77 on the indicia layer 48, or any other portion of the film 46. For example, the diffraction grating 77 may be configured to reflect light in different directions from a top side of the indicia layer 48. The diffraction grating 77 may have a thickness that ranges from about 250 nm to about 1000 nm.

As depicted in FIG. 6 in exemplary form, the diffraction grating 77 may have a sawtooth or triangular shape. In three dimensions, these gratings 77 42 can appear with a stepped or sawtooth shape without angular features, pyramidal in shape, or some combination of stepped and pyramidal shapes. Other shapes of the diffraction grating 77 include hill-shaped features (e.g., sinusoidal or curved shaped features). The diffraction grating 77 can also include portions with a combination of triangular and hill-shaped features.

Referring to FIG. 7, a block diagram of the vehicle 30 is generally shown in which the trim member 32 is implemented. The vehicle 30 includes the controller 64 in communication with the light source 50. The controller 64 may include memory 94 having instructions contained therein that are executed by a processor 96 of the controller 64. The controller 64 may provide electrical power to the light source 50 via a power source 66 located onboard the vehicle 30. In addition, the controller 64 may be configured to control the excitation light 24 based on feedback received from one or more inputs.

The inputs that affect the illumination of the trim member 32 may include sound characteristics 98 from an audio system, information provided by vehicle control modules 100, and/or trim member 32 illumination settings that may be inputted through a user interface 102. The sound characteristics 98 include frequency 104, amplitude 106, beat 108, and source 110 of inputted sounds. According to one embodiment, the wavelength of excitation light 24 emitted from the light source 50 varies as the frequency 104 and/or amplitude 106 of sound changes. Further, the beat 108 may also affect the color generation from the trim member 32. The trim member 32 may luminesce in a first color when music from the audio system is playing and may luminesce in a second color to provide additional information to an occupant of the vehicle 30. For example, the trim member 32 may luminesce in any predefined pattern when a navigation unit within the vehicle 30 is providing directional commands to the occupant and then may return to an alternative predefined pattern when the directional command is finished.

Vehicle control modules 100 such as, but not limited to, a body control module, engine control module, steering control module, brake control module, the like, or a combination thereof may also vary the colors of the trim member 32. By controlling the excitation light 24 emitted from the light source 50, the trim member 32 may luminesce in a variety of colors and/or patterns to provide an aesthetic appearance, or may provide vehicle information to an intended observer. For example, the trim member 32 may luminesce in various colors as the speed 112 and/or acceleration 114 of the vehicle 30 is varied. Also, the trim member 32 may be utilized in conjunction with the vehicle braking system 116 to provide additional illumination during a braking period.

The ambient light level 118 outside the vehicle 30 may also affect the lighting of the trim member 32. For example, the trim member 32 may luminesce at a higher intensity during the day and a lower intensity during low light conditions. Moreover, the trim member 32 may luminesce in response to a change in a vehicle door state 120, or any other change in relation to another component of the vehicle 30. Or, the trim member 32 may vary in color with changes in environmental conditions, such as road roughness 122, potential hazards, variations in weather, or for any other reason. As described herein, the luminescent structures 10a, 10b, 10c may include a long-persistence luminescent material 18 such that environmental light (i.e., the sun) may excite the luminescent structures 10a, 10b, 10c during the day thereby causing the luminescent structures 10a, 10b, 10c to luminesce in night-like conditions.

The vehicle 30 may also include a user interface 102 that an occupant may utilize for setting desired lighting effects of the trim member 32. The user interface 102 may be an independent system, or integrated into any other system, such as a human machine interface (HMI), of the vehicle 30. The user interface 102 may be configured such that a user may control the wavelength of excitation light 24 that is emitted by the light source 50 or a pattern of illumination. For example, an occupant may control the light pulse frequency 124, light pulse amplitude 126, light color variations 128, and/or individual light patterns 130 through usage of the user interface 102.

In operation, the light source 50 may emit excitation light 24 of varying wavelengths, as provided herein. In response, the luminescent structures 10a, 10b, 10c may exhibit periodic unicolor or multicolor illumination. With respect to the above examples, the controller 64 may modify the intensity of the emitted wavelengths of excitation light 24 by pulse-width modulation or current control. In some embodiments, the controller 64 may be configured to adjust a color of the excitation light 24 by sending control signals to adjust an intensity or energy output level of the light source 50. For example, if the light source 50 is configured to output the first wavelength at a low level, substantially all of the first wavelength may be converted to the second wavelength by the one or more luminescent structures 10a, 10b, 10c. If the light source 50 is configured to output the first wavelength (i.e., excitation light 24) at a high level, only a portion of the first wavelength may be converted to the second wavelength (i.e., converted light 26). In this configuration, a color of light corresponding to mixture of the first wavelength and the second wavelength may be output as the emitted light. In this way, the controller 64 may control an output color of the emitted light.

Though a low level and a high level of intensity are discussed in reference to the first wavelength of excitation light 24, it shall be understood that the intensity of the first wavelength of excitation light 24 may be varied among a variety of intensity levels to adjust a hue of the color corresponding to the emitted light from the trim member 32. The variance in intensity may be manually altered, or automatically varied by the controller 64 based on predefined conditions.

As described herein, the color of the converted light 26 may be significantly dependent on the particular luminescent materials 18 utilized in the luminescent structures 10a, 10b, 10c. Additionally, a conversion capacity of the luminescent structures 10a, 10b, 10c may be significantly dependent on a concentration of the luminescent material 18 utilized in the luminescent structures 10a, 10b, 10c. By adjusting the range of intensities that may be output from the light source 50, the concentration, types, and proportions of the luminescent materials 18 in the luminescent structures 10a, 10b, 10c discussed herein may be operable to generate a range of color hues of the emitted light by blending the first wavelength with the second wavelength.

A variety of advantages may be derived from the use of the present disclosure. For example, use of the disclosed trim member provides a unique aesthetic appearance to the vehicle. Moreover, the trim member may provide additional visual information to the occupants of the vehicle. Lastly, through the usage of multiple light sources and/or multiple luminescent structures, a wide array of patterns and appearances may be conferred by the trim member.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited, to physically mateable and/or physically interacting components and/or wirelessly interactable and/or wirelessly interacting components and/or logically interacting and/or logically interactable components.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. A vehicle film comprising:
a base layer;
a light guide disposed above a surface of the base layer;
an indicia layer operably coupled with the light guide, the indicia layer having first and second sheets having first and second luminescent structures respectively thereon; and
a light source operably coupled with the light guide, wherein the first and second luminescent structures luminesce in response to an excitation light emitted by the light source.

2. The vehicle film of claim 1, wherein the excitation light comprises at least one of blue light, violet light, infrared and ultraviolet light.

3. The vehicle film of claim 2, wherein the first luminescent structure and the second luminescent structure each include at least one luminescent material therein configured to convert the excitation light received from the light source into a visible converted light.

4. The vehicle film of claim 1, wherein the first luminescent structure is configured as a background layer and the second luminescent structure defines a pattern on the background layer.

5. The vehicle film of claim 4, wherein the first and second luminescent structures define a woodgrain pattern.

6. The vehicle film of claim 4, further comprising:
a third sheet having a third luminescent structure to further define the pattern disposed on the background layer.

7. The vehicle film of claim 1, wherein the indicia layer is embossed.

8. A trim member comprising:
a substrate;
a light source configured to emit an excitation light;
a film disposed on the substrate and having an indicia layer operably coupled with the light source; and
a first luminescent structure within the indicia layer and configured to luminesce in response to receiving the excitation light.

9. The trim member of claim 8, further comprising:
a second luminescent structure disposed within the indicia layer.

10. The trim member of claim 9, wherein the first luminescent structure and the second luminescent structure each include at least one luminescent material therein configured to convert the excitation light received from the light source into a visible converted light.

11. The trim member of claim 8, further comprising:
a protective layer disposed over the indicia layer.

12. The trim member of claim 11, wherein the protective layer filters the excitation light emitted from the light source from transmitting therethrough.

13. The trim member of claim 9, wherein the first and second luminescent structures may independently luminesce in response to excitation light emitted by the light source.

14. The trim member of claim 8, wherein the indicia layer is embossed.

15. A vehicle trim member comprising:
a substrate;
a film disposed on the substrate and having an embossed indicia layer;
a first luminescent structure disposed within the indicia layer and configured to luminesce in response to receiving an excitation light;
a protective layer disposed above the indicia layer; and
first and second light sources configured to emit light at opposing sides of the indicia layer causing the first luminescent structure to luminesce.

16. The vehicle trim member of claim 15, wherein the excitation light is ultraviolet light.

17. The vehicle trim member of claim 15, further comprising:
a light guide disposed between the first light source and the indicia layer.

18. The vehicle trim member of claim 16, wherein the first luminescent structure is configured as a background layer and a second luminescent structure defines a pattern on the background layer.

19. The vehicle trim member of claim 15, wherein the first light source includes a plurality of LED sources.

20. The vehicle trim member of claim 15, wherein at least one of the first and second light sources illuminate based on at least one of a sound characteristic, a vehicle control module, or a user interface.
